(19) United States
(12) Patent Application Publication
(10) Pub. No.: US 2012/0199369 A1
(43) Pub. Date: Aug. 9, 2012

(54) Illuminating hoof-pick

(76) Inventors: Carolyn June Taylor, Hanover, IN (US); Robert Ryan Taylor, Hanover, IN (US)

(21) Appl. No.: 13/374,450

(22) Filed: Feb. 1, 2012

Related U.S. Application Data
(60) Provisional application No. 61/439,908, filed on Feb. 6, 2011.

(51) Int. Cl. A01L 11/00

(52) U.S. Cl. 168/48.1

(57) ABSTRACT

A hoof-pick is an equine tool resembling a screwdriver with a bent blade. It is used to “pick-out” or clean and examine the sole of a horse's hoof. The hoof-pick can be either a curved hook style or standard bent or “spade” blade. An illuminating hoof-pick has a LED (light emitting diode) built into the rubber or molded plastic handle. The LED wiring and resistor is housed in a protective tube built into the underside of the molded handle. One wire in the assembly goes to the contact spring; the other to a conducting battery tube on the contact board. The LED is activated by a push button on-off switch and powered by a “AAA” battery. The technology is basically the same as a flashlight. The LED light would be mounted on the base of the hook. This position would illuminate the proper area to be cleaned or examined.

### CROSS REFERENCE TO RELATED APPLICATIONS

This application claims the benefit of provisional patent application Ser. No. 61/439,908, filed 2011 Feb. 6 by the present inventors, United States citizens

This invention relates to an equine tool used to clean horses' hooves. Specifically, it relates to such a tool equipped with a light emitting diode for illuminating the hoof area.

A hoof-pick is an equine tool used to clean the soles of a horse's hoof. It resembles a screwdriver with a curved or spade hook at the end of the blade. The pick has a grip handle and is used with a lever action. As an older horse owner, I found it difficult to see to clean out my horses' hooves in poorly lit areas. I could not easily check for bruising and abscesses. Currently, hoof-picks do not have a built in light source to illuminate the sole of the horses' hoof to be examined. Headlamps and flash lights are used to illuminate while using a pick. These methods do not work efficiently. Using a flashlight, does not leave both hands free to pick up and hold the hoof and clean or “pick”. Headlamps do not direct the light to the proper area. I thought of putting the light directly on the pick itself. Correct placement of the light would illuminate the area I needed to see. The light (LED) would be activated by a simple push button switch. Having worked with LED's in the automotive industry, I knew that they would provide the brightness I needed. An LED would be small enough to fit in the handle of an existing pick design. It would work off a “AAA” battery pack molded in the handle. It would be adaptable to all types of existing pick designs. The related provisional patent is simple and based on the need of a better hoof-pick. By putting a light directly on an existing design, both hands are free to pick-up the hoof and use the tool. The hoof can be properly cleaned of stones, mud, and foreign debris with the benefit of better lighting. Also, by lighting the hoof area at close proximity, one can identify hoof problems more easily. Currently, existing designs of hoof-picks do not offer the convenience of cleaning and illuminating simultaneously. The latest improvement on this tool was a design making the handle ergonomic and the blade stronger. This is referred to as the “Ultimate Hoof-pick and currently has a patent pending. However, this design does not incorporate the use of a light.

This invention would be beneficial to farriers, veterinarians, and all horse owners. Its use in dimly lit barns or areas would allow a farrier or veterinarian to better evaluate the hoof area. By placing a light directly on the questionable area, a user could more readily see a problem. It would enable a user to treat bruising and/or abscessing. This may be overlooked without direct lighting. On evening rides, it would be invaluable in cleaning out stones and debris picked up on the trail, thus, eliminating lameness and discomfort to the horse. Overall, it would enable older horse owners to more easily care for their animals by putting “a light on the subject”. Besides the advantages listed above, several more aspects are listed below:
(a) Can be adapted to existing hoof-pick designs
(b) Would be economical to purchase as components are cheap and available
(c) Would provide a convenient source of light in a small package
(d) Can be conveniently carried for portable use
(e) Improvement on a widely used tool

In conclusion, an illuminating hoof-pick is a widely used equine tool. Using the design of a standard hoof-pick, its unique feature is the addition of a light source in the molded plastic or rubber grip handle.

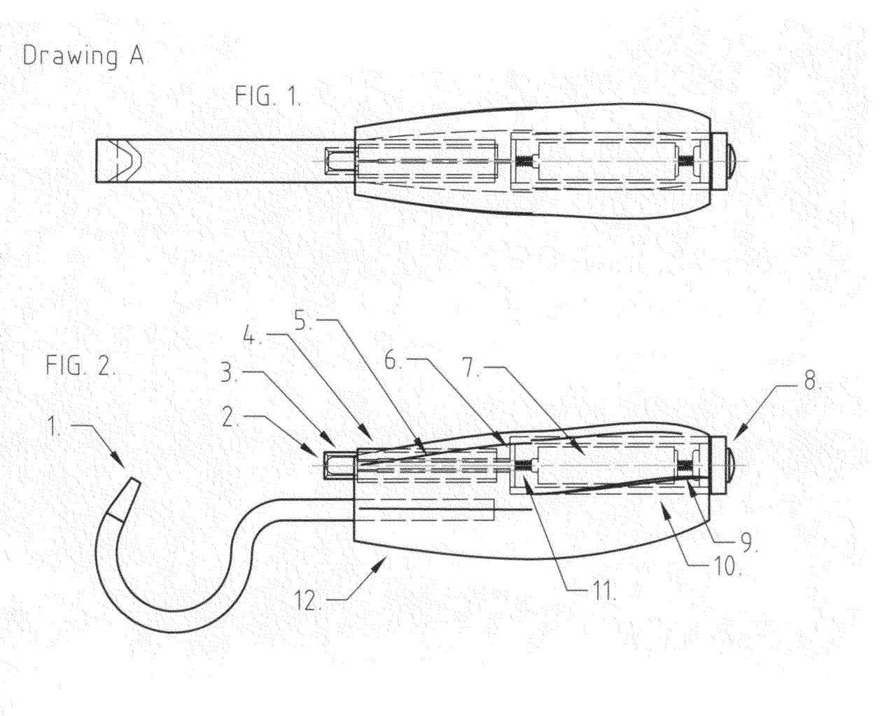

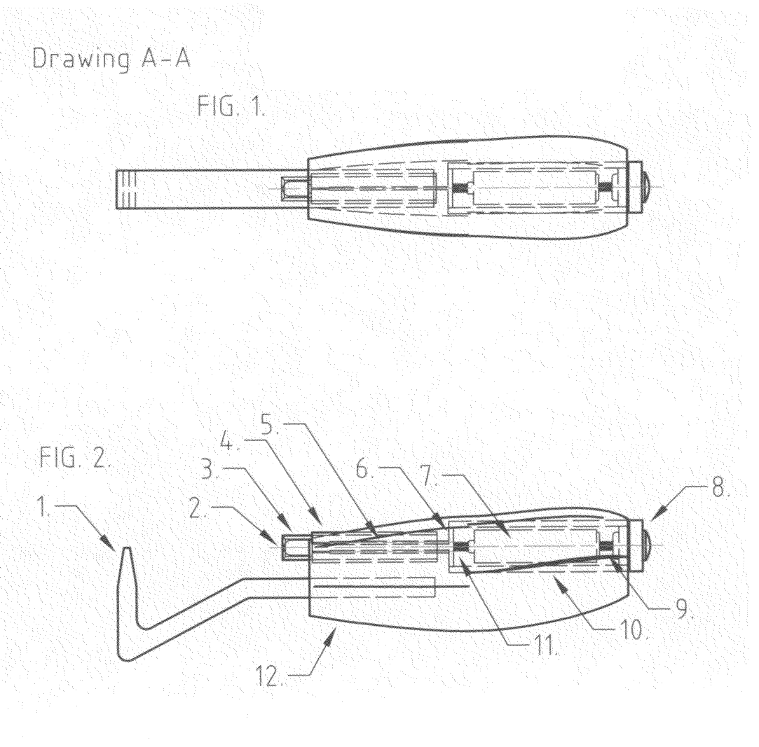

In the drawings, closely related figures provide different views of the equine tool. Drawing A, FIG. 1 is a hoof-pick with a curved tip. It is seen from the top side, outlining the placement of plastic tubes housing the battery, wiring, and LED. Drawing A, FIG. 2 is a curved hook style pick as seen from the side. In FIG. 2, number 1 defines the stainless steel hook which is inserted approximately 2 inches into the handle for durability. Number 2 shows the placement of the white LED, while number 3 shows its housing. Numbers 4 and 5 refer to plastic tubing and LED wiring and resistor placement of the “AAA” battery. Number 8 denotes the push button on/off switch which threads into the battery tube. Numbers 9 and 11 are the necessary contact springs attached to the click switch and contact board. Number 10 denotes the conductive battery tube housed in the molded rubber or plastic grip handle (number 12). Drawing AA, FIGS. 1 and 2 show a spade tip design, number 1 showing the spade tip on FIG. 2, numbers 2 and 3 referring to the LED and its housing, numbers 4 and 5 showing the wire resistor tube and the LED wiring and, resistor and numbers 6 and 7 showing the electrical contact board and placement of the “AAA” battery. The on/off click switch that threads into the battery tube is indicated by number 8. Numbers 9, 10, and 11 comprise the contact spring, attached to the click switch, the conductive battery tube and the contact spring attached to the contact board. The rubber or plastic molded grip handle is illustrated by number 12. Drawing B shows several views of the pick.

FIG. 1 depicts the curved hook as seen from the top side.

FIG. 2 is the curved hook, seen from the side. It shows the placement of the LED, light tube and protective wiring tube.

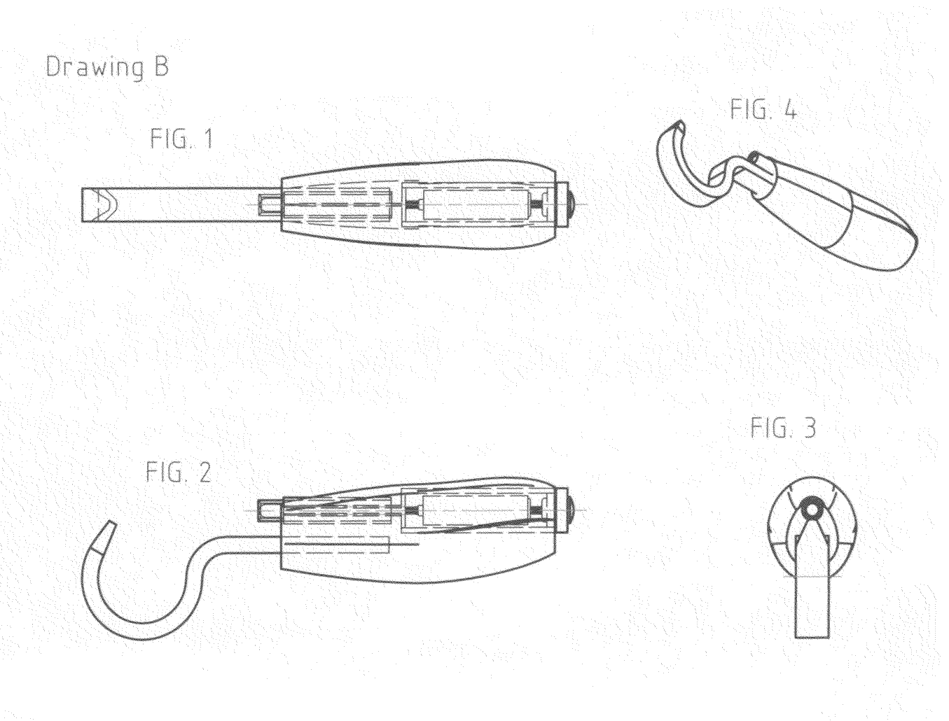

FIG. 3 show the front view of the curved hook with the placement of the light source.

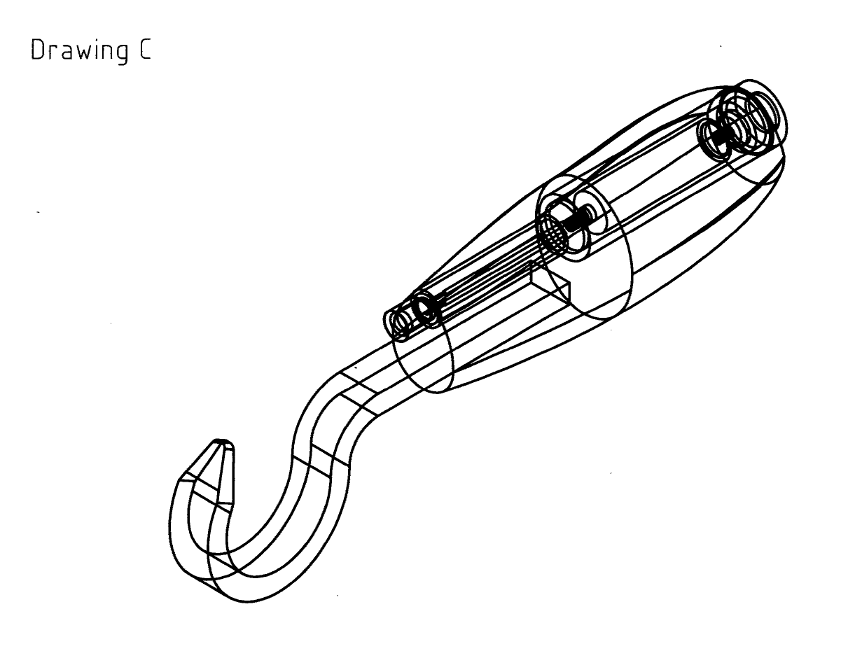

FIG. 4 shows a isometric view of the curved hook pick emphasizing the LED placement. Drawing C is a three dimensional curved hook drawn to scale.

Claims: Our idea of an illuminating hoof-pick is an equine cleaning tool comprised of a:
a. elongated steel blade with a curved or spade tip protruding from the end of a grip handle
b. grip handle molded of plastic and/or rubber
c. on/off click switch located at the end of the grip handle on the opposite side of the steel blade which can be fastened to the battery tube for operation, or removed from the battery tube for battery insertion or replacement
d. conductive battery tube, located inside the handle, with an electrical contact board located on the end of the tube opposite the on/off click switch
e. electrical contact board made of a contact spring to contact the battery, a board made of non-conductive material to isolate the points of contact of the positive and negative flow of electricity from each other, where the contact spring is utilized for the positive flow, and a point of contact with the battery tube is utilized for the negative flow, thus producing two isolated contact points on the opposite side of the board
f. two separate wires which attach independently to the isolated contact points located on the electrical contact board, and attach independently to the proper leads of the LED
g. plastic tube located inside the handle which is used to route the wires from the contact board to the LED, and help protect the wiring
h. plastic LED housing surrounding the LED in order to protect the bulb
i. LED bulb protruding from the handle, pointing toward the general work area of the steel hook, to illuminate both the hook as well as the area of the hoof being cleaned

### SUMMARY

An illuminating hoof pick will benefit farriers, veterinarians, and all horse owners. The ability to light the area of the hoof would be invaluable in dimly lit areas. Cleaning and inspecting the hoof surface is a daily activity for horse owners. Horse owners have a saying, “no hoof, no horse”. This emphasizes the importance of a good hoof tool. An illuminating hoof-pick would make the daily cleaning and inspection easier and more reliable. A bright LED could show bruising and/or damage to the sold of the hoof. This could easily be missed in natural or dim lighting. The tool could be used with or without the benefit of the light. The on/off switch in the handle could be activated as needed. The “AAA” battery is economically replaceable. The LED light would be placed in an existing hoof-pick design, either flat or curved. Thus, it should be affordable for all horse owners.

1. Our idea of an illuminating hoof-pick is an equine cleaning tool comprised of a:
a. elongated steel blade with a curved or spade tip protruding from the end of a grip handle.
b. grip handle molded of plastic and/or rubber.
c. on/off click switch located at the end of the grip handle on the opposite side of the steel blade which can be fastened to the battery tube for operation, or removed from the battery tube for battery insertion or replacement.
d. conductive battery tube, located inside the handle, with an electrical contact board located on the end of the tube opposite the on/off click switch.
e. electrical contact board made of a contact spring to contact the battery, a board made of non-conductive material to isolate the points of contact of the positive and negative flow of electricity from each other, where the contact spring is utilized for the positive flow, and a point of contact with the battery tube is utilized for the negative flow, thus producing two isolated contact points on the opposite side of the board.
f. two separate wires which attach independently to the isolated contact points located on the electrical contact board, and attach independently to the proper leads of the LED.
g. plastic tube located inside the handle which is used to route the wires from the contact board to the LED, and help protect the wiring.
h. plastic LED housing surrounding the LED in order to protect the bulb.
i. LED bulb protruding from the handle, pointing toward the general work area of the steel hook, to illuminate both the hook as well as the area of the hoof being cleaned.
